(19) United States
(12) Patent Application Publication
(10) Pub. No.: US 2012/0116572 A1
(43) Pub. Date: May 10, 2012

(54) METHODS AND SYSTEMS FOR SORTING EAR CORN

(75) Inventors: Steven J. Corak, Raleigh, NC (US); James L. Hunter, Littleton, CO (US); Yong G. Lee, Johnston, IA (US); Loren Steenhoek, Ankeny, IA (US)

(73) Assignee: PIONEER HI-BRED INTERNATIONAL, INC, Johmston, IA (US)

(21) Appl. No.: 13/289,843

(22) Filed: Nov. 4, 2011

Related U.S. Application Data
(60) Provisional application No. 61/411,750, filed on Nov. 9, 2010.

(51) Int. Cl. B07C 5/00; G06F 7/00

(52) U.S. Cl. 700/223; 901/46

(57) ABSTRACT

A system and method for sorting ear corn are provided. The system may include a transport device for transporting ear corn along a processing path and an ear corn husking stage for removing husks from the ear corn. The system may further include an ear corn sorting stage for sorting the ear corn downstream from the ear corn husking stage. The ear corn sorting stage may include one or more sensor devices for identifying and determining a location of the ear corn having at least one defined characteristic. Further, the ear corn sorting stage may include robotic devices for picking up the identified ear corn and placing the identified ear corn in an alternate location. Thereby, for example, the ear corn may be returned to the husking stage, a flawed portion of the ear corn may be removed, or the ear corn may be disposed of

### CROSS-REFERENCE TO RELATED APPLICATIONS

The present application claims priority from U.S. Provisional Application No. 61/411,750, filed Nov. 9, 2010, which is hereby incorporated herein by reference in its entirety.

### FIELD OF THE INVENTION

The present invention relates generally to methods and systems for sorting ear corn. More specifically, the present invention provides methods and systems for sorting ear corn using at least one sensor device and at least one robotic device.

### BACKGROUND OF THE INVENTION

The production and sale of corn seed may require careful processing steps in order to ensure the production of a seed product which meets purity, quality, and other standards. Further, these standards must be met while obtaining the maximum amount of useable corn seed from the ear corn. In this regard, sorting ear corn must be carefully conducted in order to ensure the relevant purity and quality standards are met and the maximum amount of useable corn seed is produced. Additionally, high throughput processing of the ear corn may in some circumstances be required in order to produce the corn seed in a rapid fashion.

In this regard, present sorting of ear corn in the production of corn seed may be conducted manually, through use of human workers. For example, workers may be positioned along a conveyor belt after a husking device which is configured to remove husks from ears of corn (i.e. “de-husk” or, for short, “husk” the ears of corn). The workers may thereby sort the ear corn based on one or more factors. For example, if the ear corn are not properly husked or otherwise unacceptable, they may be returned to the husking device or disposed of. Accordingly, use of manual labor for ear corn sorting may satisfy the goals of maximum production of corn seed while also maximizing quality and throughput, due to the scalability of the labor force.

### BRIEF SUMMARY OF VARIOUS EMBODIMENTS

The present invention addresses the above needs and achieves other advantages by providing a system and method of sorting ear corn. In general, the method comprises transporting ear corn along a processing path using a transport device, the processing path including an ear corn husking stage, and sorting the ear corn at an ear corn sorting stage located along the processing path downstream from the ear corn husking stage, wherein sorting the ear corn comprises using one or more sensor devices to identify and determine a location on the processing path of the ear corn having at least one defined characteristic, and using one or more robotic devices to pick up the identified ear corn and place the identified ear corn in an alternate location. In some embodiments, the one or more sensor devices comprise a machine-vision sensor device. In some embodiments, using the one or more sensor devices comprises using a first sensor device to identify the at least one defined characteristic and using a second sensor device to determine the location on the processing path. In some embodiments, using the first sensor device comprises using the first sensor device to set one or more control limits, and using the second sensor device comprises using the second sensor device to determine the location of ear corn meeting or exceeding the control limits.

In some embodiments, using the one or more sensor devices comprises using the one or more sensor devices to identify husk material. In some embodiments, using the one or more sensor devices comprises using the one or more sensor devices to identify ear corn with a fungal infection. In some embodiments, using the one or more sensor devices comprises using the one or more sensor devices to identify moisture content greater than a threshold value. In some embodiments, using the one or more sensor devices comprises using the one or more sensor devices to identify immature ear corn. In some embodiments, using the one or more sensor devices comprises using the one or more sensor devices to identify ear corn having a phenotype other than a preferred phenotype. In some embodiments, the one or more sensor devices are included on one or more of the robotic devices.

In some embodiments, the alternate location comprises a second processing path that leads the identified ear corn back to the ear corn husking stage. In some embodiments, the alternate location comprises an ear corn recovery stage, and the method further comprises removing at the ear corn recovery stage a flawed portion of at least one identified ear corn, wherein the flawed portion contains the defined characteristic, and transporting a remaining portion of the at least one identified ear corn back to the processing path. In some embodiments, the alternate location comprises a disposal location. In some embodiments, sorting the ear corn further comprises using the one or more sensor devices to identify ear corn having a second defined characteristic. In some embodiments, using the one or more robotic devices comprises using a first robotic device to pick up the identified ear corn from a first group and place the identified ear corn from the first group in the alternate location and using a second robotic device to pick up the identified ear corn from a second group and place the identified ear corn from the second group in the alternate location. In some embodiments, using the one or more robotic devices comprises using a first robotic device to pick up the identified ear corn having a first defined characteristic and place the identified ear corn having the first defined characteristic in a first alternate location and using a second robotic device to pick up the identified ear corn having a second defined characteristic and place the identified ear corn having the second defined characteristic in a second alternate location. In some embodiments, sorting the ear corn occurs while the ear corn is being transported along the processing path. In some embodiments, sorting the ear corn occurs while the ear corn is temporarily paused along the processing path.

Another embodiment of the present invention provides a system for sorting ear corn. In general, the system comprises a transport device configured to transport ear corn along a processing path, an ear corn husking stage located along the processing path and configured to remove husks from the ear corn, and an ear corn sorting stage located along the processing path downstream from the ear corn husking stage and configured to sort the ear corn, wherein the ear corn sorting stage comprises: one or more sensor devices configured to identify and determine a location on the processing path of the ear corn having at least one defined characteristic, and one or more robotic devices configured to pick up the identified ear corn and place the identified ear corn in an alternate location. In some embodiments, the one or more sensor devices comprise a machine-vision sensor device.

In some embodiments, the defined characteristic comprises husk material. In some embodiments, the defined characteristic comprises ear corn with a fungal infection. In some embodiments, the defined characteristic comprises moisture content greater than a threshold value. In some embodiments, the defined characteristic comprises immature ear corn. In some embodiments, the defined characteristic comprises ear corn having a phenotype other than a preferred phenotype. In some embodiments, the alternate location comprises a second processing path configured to lead the identified ear corn back to the ear corn husking stage. In some embodiments, the alternate location comprises an ear corn recovery stage configured to remove a flawed portion of at least one identified ear corn, wherein the flawed portion contains the defined characteristic, and transport a remaining portion of the at least one identified ear corn back to the processing path. In some embodiments, the alternate location is a disposal location.

In some embodiments, the one or more sensor devices are configured to identify ear corn having a second defined characteristic. In some embodiments, the one or more sensor devices comprise a first sensor device configured to identify the at least one defined characteristic and a second sensor device configured to determine the location on the processing path. In some embodiments, the first sensor device is included on one or more of the robotic devices. In some embodiments, the second sensor device is included on one or more of the robotic devices. In some embodiments, the one or more robotic devices comprise a first robotic device and a second robotic device, wherein the first robotic device is configured to pick up the identified ear corn from a first group and place the identified ear corn from the first group in the alternate location, and wherein the second robotic device is configured to pick up the identified ear corn from a second group and place the identified ear corn from the second group in the alternate location. In some embodiments, the one or more robotic devices comprise a first robotic device and a second robotic device, wherein the first robotic device is configured to pick up the identified ear corn having a first defined characteristic and place the identified ear corn having the first defined characteristic in a first alternate location, and wherein the second robotic device is configured to pick up the identified ear corn having a second defined characteristic and place the identified ear corn having the second defined characteristic in a second alternate location. In some embodiments, the ear corn sorting stage is configured to sort ear corn while the ear corn is being transported along the processing path. In some embodiments, the ear corn sorting stage is configured to sort ear corn while the ear corn is temporarily paused along the processing path.

The present invention also provides another embodiment directed to a method of sorting ear corn. In general, the method comprises transporting ear corn along a processing path using a transport device, and sorting the ear corn at an ear corn sorting stage located along the processing path, wherein sorting the ear corn comprises: using one or more sensor devices to identify and determine a location on the processing path of the ear corn having at least one defined characteristic, and using one or more robotic devices to pick up the identified ear corn and place the identified ear corn in an alternate location.

The present invention also provides another embodiment directed to a system for sorting ear corn. In general, the system comprises a transport device configured to transport ear corn along a processing path, and an ear corn sorting stage located along the processing path and configured to sort the ear corn, wherein the ear corn sorting stage comprises: one or more sensor devices configured to identify and determine a location on the processing path of the ear corn having at least one defined characteristic, and one or more robotic devices configured to pick up the identified ear corn and place the identified ear corn in an alternate location.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a schematic view of a system for sorting ear corn according to an example embodiment of the invention;

FIG. 2 illustrates a perspective view of a portion of the system of FIG. 1 according to an example embodiment of the invention;

FIG. 3A illustrates a first embodiment of a grasping device comprising a vacuum-assisted tip in the form of a portion of a cylinder according to an example embodiment of the invention;

FIG. 3B illustrates the grasping device of FIG. 3A attempting to pick up an identified ear corn according to an example embodiment of the invention;

FIG. 4A illustrates a second embodiment of a grasping device comprising a pair of prongs according to an example embodiment of the invention;

FIG. 4B illustrates the grasping device of FIG. 4B picking up an identified ear corn according to an example embodiment of the invention;

FIG. 5A illustrates a third embodiment of a grasping device comprising a vacuum-assisted suction tip according to an example embodiment of the invention;

FIG. 5B illustrates the grasping device of FIG. 5A picking up an identified ear corn according to an example embodiment of the invention; and

FIG. 6 illustrates a method of sorting ear corn according to an example embodiment of the invention.

### DETAILED DESCRIPTION

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As described above, manual labor achieves many of objectives associated with sorting ear corn. However, manual labor suffers from several disadvantages. For example, safety may be an issue when the manual laborers work near moving equipment or the sorting requires repetitive motions, lifting of weight, bending over, etc. Further, employment of people may require administrative costs in the form of hiring costs, training, supervision, etc. Additionally, whenever production is paused, for example due to a mechanical breakdown, the workers may still need to be paid despite the downtime. Further, labor rates may continue to increase, which may reduce the feasibility of employing a large labor force for sorting. Also, labor shortages may exist, for example, in rural communities for undesirable shifts. Accordingly, while manual labor may provide some benefits, it may present an imperfect solution. Further, replacing manual labor with machinery such as air jets, pushers, plows-offs, or other non-robotic devices for sorting ear corn may be impractical due to the size of ear corn and potential for the ear corn to be positioned close to one another, which may make some mechanized sorting difficult. Note, however, that in some embodiments manual labor may still be employed for purposes of secondary quality control, or for purposes of discarding objects such as rocks and corn stalks which may enter the production line inadvertently.

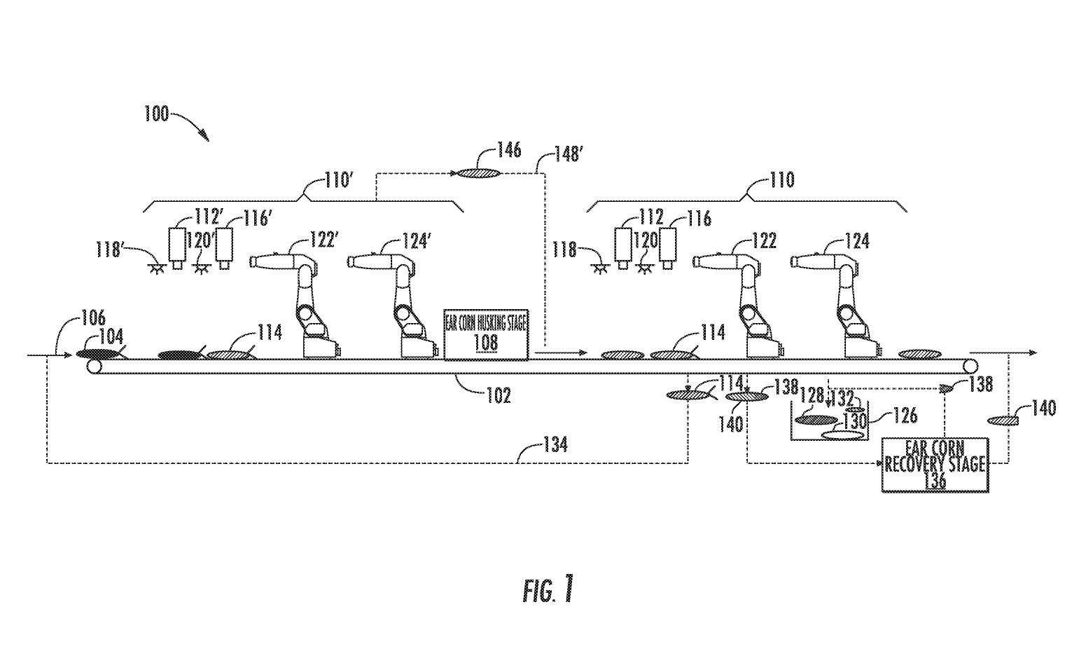

Thus, as will be described herein, the present application is generally directed to improved methods and systems for sorting ear corn. In this regard, FIG. 1 illustrates a schematic view of a system 100 for sorting ear corn according to an example embodiment. The system 100 may comprise a transport device, such as the illustrated conveyor belt 102, which is configured to transport ear corn 104 along a processing path 106. Note that the term processing path, as used herein, does not require that the ear corn be physically processed, but instead refers to a conveyance path along which the ear corn are directed, although physical processing of the ear corn may occur in some embodiments. The ear corn 104 may be randomly arranged on the conveyor belt 102, or the ear corn may be aligned or otherwise positioned in an ordered fashion, for example in rows on the conveyor belt. An ear corn husking stage 108 may be located along the processing path 106 and configured to remove husk material from the ear corn 104. An ear corn sorting stage 110 may be located on the processing path 106 downstream from the ear corn husking stage 108 and configured to sort the ear corn. The processing path 106 may thereafter lead to additional processing of the ear corn, such as ear corn drying and seed shelling (i.e. seed removal) downstream of the ear corn sorting stage 110. Thereby, corn seed may ultimately be produced, and as will be described below, the quality of the corn seed may be improved. Note that the term downstream, as used herein, refers to placement on the processing path 106 which is generally after the referenced item in terms of the usual movement of the ear corn.

The ear corn sorting stage 110 may comprise one or more sensor devices configured to identify and determine the location on the processing path 106 of ear corn having at least one defined characteristic. In some embodiments a first sensor device 112 may be configured to identify the at least one defined characteristic. In this regard, defined characteristics, as used herein, may refer to a variety of aspects of the ear corn in various embodiments of the system 100. For example, in one embodiment a defined characteristic may comprise husk material. Identification of husk material downstream of the ear corn husking stage 108 may be desirable. In the illustrated embodiment, for example, the ear corn sorting stage 110 is downstream of the ear corn husking stage 108. In this regard, the ear corn husking stage 108 may not operate with a perfect success rate, and hence it may be possible for partially husked (or fully unhusked) ear corn 114 to exit the ear corn husking stage and continue on the processing path 106. As described above, in some embodiments the ear corn may later be dried and shelled and the kernels may be packaged as seed. In such instances it may be difficult to dry and shell partially husked ear corn, and hence it may be desirable to identify ear corn 114 which are partially husked.

Further defined characteristics may comprise moldy ear corn kernels or ear corn with other fungal infections. In this regard moldy ear corn may be undesirable when producing seed from the ear corn. In an additional example embodiment, the defined characteristic may comprise other defects in the ear corn. For example, all or a flawed portion of some ear corn may have defects such as damage from insects. In another embodiment the defined characteristic may comprise ear corn having a phenotype other than a preferred phenotype. For example, when producing seed it may be desirable to produce seed which is substantially entirely from the same genotype, which may be represented by the phenotype. Thereby, it may be desirable to identify ear corn having a phenotype other than the preferred phenotype.

In a further example embodiment, the defined characteristic may comprise immature ear corn. For example, not all plants may develop ear corn at the same rate, and hence harvesting the ear corn may result in production of ear corn in various states of development. Further, some plants may produce multiple ears of corn on the same plant, and the ears of corn may be of different levels of maturity. Use of immature ear corn for seed production may be undesirable because this may result in an increased chance of having outcross seed and/or reduced viability. In some embodiments immature ear corn may be defined as ear corn which has not fully developed, thus in some embodiments immature ear corn may be identified based on the size of the ear corn and/or the size of the kernels on the ear corn. Further, in some embodiments immature ear corn may be identified based on color, composition, or other criteria. For example, in some instances immature ear corn may comprise a relatively higher moisture content than the moisture content of fully developed ear corn. Accordingly, in some embodiments the defined characteristic may comprise moisture content greater than a threshold value. Thereby, for example, the threshold value may be selected based on an expected moisture content of mature ear corn which are fully developed or developed to a sufficient maturity level.

The first sensor device 112 may identify one or more defined characteristics associated with the ear corn such as those described above. However, various other defined characteristics may be alternatively or additionally identified by the first sensor device 112. Additionally, the ear corn husking stage 110 may comprise a second sensor device 116 configured to determine the location on the processing path 106 of the ear corn. Determining the location on the processing path 106 of the ear corn may in some embodiments comprise determining both the center of the ear corn and the perimeter of the ear corn. Although shown as two separate sensor devices in the illustrated embodiment, in some embodiments the first sensor device 112 and the second sensor device 116 may comprise a single sensor device. Thereby, in some embodiments a single sensor device may be configured to both identify and determine the location on the processing path 106 of ear corn having at least one defined characteristic.

For example, in some embodiments the single sensor device may comprise a machine-vision sensor device. Machine-vision sensor devices, as used herein, refer to apparatuses which use electronic sensory equipment to electronically identify sizes, shapes, colors, patterns, orientation, and/or other characteristics of objects. In this regard, the machine-vision sensor device will generally be described herein as being camera-based for purposes of brevity. However, the machine-vision sensor device may in some embodiments comprise x-ray equipment, magnetic resonance imaging (MRI) equipment, laser three-dimensional (“3-D”) scanners, and various other equipment configured to identify sizes, shapes, patterns, orientation, colors, and or other characteristics of objects.

As mentioned above, in some embodiments the machine-vision sensor device may comprise a camera or a video camera. Thereby, for example, the machine-vision sensor device may identify ear corn having a defined characteristic by identifying certain sizes, colors, shapes, or other data within captured images or other acquired data. By way of further example, the machine-vision sensor device may determine the location on the processing path 106 of the ear corn by determining the position of the defined characteristic within the captured image and then converting the location within the captured image to a location along the processing path. For example, the machine-vision sensor device may capture images or otherwise acquire data having a specified resolution. Thereby each acquired data point may be mapped to a location along the processing path 106 based on the distance and angle defined between the machine-vision sensor device and the portion of the conveyor belt 102 being captured, lens zoom, etc. Accordingly, in some embodiments a single sensor device may both identify and determine the location on the processing path 106 of ear corn having a defined characteristic. However, the above described uses of sensor devices to identify and locate ear corn may also be used in embodiments in which the first sensor device 112 performs identification and the second sensor device 116 determines location. For example, the first sensor device 112 may be used to set one or more control limits, by identifying the defined characteristics and establishing control limits indicating what is or is not acceptable. By way of further example, the first sensor device 112 may detect ear corn size and the control limits may specify acceptable or unacceptable size based on the detected sizes. Further, the second sensor device 116 may then be used to determine the location of ear corn meeting or exceeding the control limits. In the example embodiment, this may comprise determining the location of ear corn which meet or exceed the ear corn size control limits. Accordingly, one or both of the first sensor device 112 and the second sensor device 116 may also comprise machine-vision sensor devices in embodiments in which more than one sensor device is employed.

It is of note that the order in which the one or more defined characteristics are identified and the location on the processing path 106 is determined may vary depending on the specific embodiment of the system 100. For example, in some embodiments the location of the ear corn may be determined followed by identifying at least one defined characteristic. However, in other embodiments the at least one defined characteristic may be identified followed by determining the location on the processing path 106 of the ear corn having the at least one defined characteristic. Further, in some embodiments identifying the at least one defined characteristic may occur substantially simultaneously with determining the location of the ear corn having the at least one defined characteristic on the processing path 106. For example, when a single sensor device both identifies and determines the location on the processing path 106 of ear corn having at least one defined characteristic, the information provided by the sensor may be processed at substantially the same time to identify the at least one defined characteristic and determine the location on the processing path of the ear corn having the at least one defined characteristic.

Further, a machine-vision sensor device may capture or otherwise acquire data in the visible spectrum, infrared spectrum, near-infrared spectrum, ultraviolet spectrum, or data of other wavelengths and/or other optical properties in various embodiments. Accordingly, the system 100 may further comprise a light source 118 which is configured to direct light onto the ear corn. The light source may be configured to output visible light, infrared light, near-infrared light, ultraviolet light, etcetera depending on the defined characteristic which the sensor device is configured to identify. In some embodiments the system 100 may further comprise a second light source 120 which is configured to direct light onto the ear corn. The second light source 120 may, for example, direct a different type of light onto the ear corn as compared to light source 118 to thereby assist in identifying a different defined characteristic. Alternatively, one of the light sources 118, 120 may assist in identifying ear corn having a defined characteristic whereas the other light source may assist in determining the location on the processing path 106 of the ear corn. For example, the first sensor device 112 may acquire data in the ultraviolet or infrared spectrum and the second sensor device 116 may acquire data in the visible spectrum. In this regard, for example, some molds or other fungi may fluoresce when properly illuminated in the ultraviolet or infrared spectrums, whereas it may be easier to determine the location of the identified ear corn using visible light. Thus, in some embodiments the light source 118 may emit ultraviolet or infrared light whereas the second light source 120 may emit visible light. In this regard, the sensor devices 112, 116 may be tailored for the tasks they perform. For example, various filters, lenses, exposure times, and sensor resolutions may be employed to suit the specified performed tasks. Further, the material and/or color forming the conveyor belt 102 or other transport device may be selected to not interfere with identifying and locating ear corn comprising the defined characteristic. For example, the conveyor belt 102 may comprise a color which is different from any color associated with any of the defined characteristics.

Note that while the above description generally describes a single sensor device (either the first sensor device 112 or a combined sensor device) as being configured to identify a defined characteristic, in some embodiments the system 100 may further comprise additional sensor devices configured to identify ear corn having a second defined characteristic. For example, the first sensor device 112 may be configured to identify moldy ear corn kernels and an additional sensor device may be configured to identify ear corn having husk material. For example, the second sensor device 116 may be configured to identify a second defined characteristic. By way of further example, when the second sensor device 116 is configured to acquire data in the visible spectrum to determine the location on the processing path 106 of the ear corn, the second sensor device may also identify a second defined characteristic when the second defined characteristic is identifiable by acquiring data from the visible spectrum.

Thereby, various combinations of sensor devices and uses thereof are possible in identifying and determining the location on the processing path 106 of ear corn having defined characteristics. Thus, this information may be used for sorting the ear corn. In this regard, the ear corn sorting stage 110 may further comprise one or more robotic devices configured to pick up or otherwise move the identified ear corn and place the identified ear corn in an alternate location. A robotic device, as used herein, may refer to an automatically guided machine or apparatus which is configured to complete tasks, and in some embodiments the robotic device may be configured to complete the tasks on its own. For example the robotic device may perform the one or more tasks by executing electronically-programmed instructions.

In the illustrated embodiment of the system 100 comprises a first robotic device 122 and a second robotic device 124 although a single robotic device or additional robotic devices may be employed in moving the identified ear corn to one or more alternate locations in some embodiments of the system. Thereby, as shown in the example embodiment of the system 100, ear corn which does not have any of the identified characteristics may continue traveling on the processing path 106 for further processing in order to produce the desired end product while ear corn having the defined characteristics are moved to one or more alternate locations.

In some embodiments the sensor devices 112, 116 may be mounted in fixed locations, as illustrated in the embodiment of the system 100 in FIG. 1. However, in other embodiments the sensor devices 112, 116 may be mounted to the robotic devices. For example, the first sensor device 112 and/or the second sensor device 116 may be included respectively on the first robotic device 122 and the second robotic device 124. Hence, in some embodiments the sensor devices 112, 116 may move with the robotic devices 122, 124. In this regard, selection of the location of the sensor devices 112, 116 may depend on the type of sensor devices and the control logic applied to the robotic devices 122, 124.

In some embodiments the alternate location may comprise a disposal location 126. By way of example, the disposal location 126 may comprise a dumpster or other discard bin or a conveyor or other transport device configured to move the identified ear corn to another location for discard. For example, identified ear corn having the defined characteristic of moldy ear kernels 128, a phenotype other than the preferred phenotype 130, or immature ear corn 132 may be disposed of.

However, in other embodiments it may be possible to still use the identified ear corn to produce the end product and hence the identified ear corn may not be disposed of. In this regard, in some embodiments the alternate location may comprise a second processing path 134. The second processing path 134 may be configured to lead the identified ear corn to alternate or additional processing. In the illustrated embodiment the second processing path 134 is configured to lead the identified ear corn back to the ear corn husking stage 108. Thereby, partially husked ears of corn 114 which are identified may be picked up or otherwise moved by the first robotic device 122 and/or the second robotic device 124 to the second processing path 134 which leads back to the beginning of the processing path 106 and accordingly through the ear corn husking stage 108. Thereby the remaining husk material may be removed from the identified ear corn which had husk material thereon and the ear corn may continue on the processing path 106. In other embodiments the partially husked ears of corn 114 may be directed on a second processing path which includes a more aggressive husking stage that is configured to remove more husk material. The second processing path 134 may comprise a conveyor belt in some embodiments. In other embodiments the first 122 or second 124 robotic device may directly move the identified ear corn back to the ear corn husking stage 108 by, for example, picking up and dropping the ear corn on the conveyor belt upstream of the ear corn husking stage, or using pneumatics to launch the ear corn through the air.

Further, in some embodiments the alternate location may comprise an ear corn recovery stage 136. The ear corn recovery stage 136 may be configured to remove a flawed portion 138 of at least one identified ear corn. The flawed portion 138 of the identified ear corn may comprise one or more of the defined characteristics. For example, some ear corn may define a flawed portion 138 comprising moldy ear corn kernels. Thereby, the ear corn recovery stage 136 may remove the flawed portion 138 of the identified ear corn from a remaining portion 140 of the identified ear corn. For example, knives or other cutting devices may remove the flawed portion 138. In some embodiments the ear corn recovery stage 136 may be configured to transport the remaining portion 140 of the at least one identified ear corn back to the processing path 106. For example, the remaining portion 140 may be returned to the ear corn sorting stage 110 to ensure that the entirety of the flawed portion 138 of the identified ear corn was successfully removed. However, in other embodiments, such as the embodiment illustrated in FIG. 1, the remaining portion 140 may be returned to the processing path 106 downstream of the ear corn sorting stage 110. Conversely, the flawed portion 138 may be, for example, directed to the disposal location 126 for disposal.

In some embodiments the first robotic device 122 may be configured to pick up or otherwise move the identified ear corn having a first identified characteristic and place the identified ear corn having the first defined characteristic in a first alternate location. Further, the second robotic device 124 may be configured to pick up the identified ear corn having a second defined characteristic and place the identified ear corn having the second defined characteristic in a second alternate location. In this regard, for example, the first robotic device 122 may be configured to pick up identified ear corn comprising husk material and move them to the second processing path 134 to thereby direct the identified ear corn through the ear corn husking stage 108 again. By way of further example, the second robotic device 124 may pick up or otherwise move the immature ear corn 132 to the disposal location 126. Accordingly, in some embodiments the robotic devices 122, 124 may respectively pick up ear corn having different defined characteristics and move them to different locations. Alternatively, however, in some embodiments both the first robotic device 122 and the second robotic device 124 may move the ear corn to the same alternate location and/or both robotic devices may each move ear corn having the same defined characteristics.

Further in some embodiments the first robotic device 122 may be configured to pick up ear corn comprising a first defined characteristic and the second robotic device 124 may be configured to pick up ear corn comprising all other defined characteristics which are identifiable, or a portion thereof. This may, for example, be used when the first defined characteristic is expected to be identified more frequently than the other defined characteristics. For example, when ears of corn with husk material are expected to be received more often than ears of corn with moldy kernels 128 or immature ear corn 132, then the first robotic device 122 may pick up the ears of corn with husk material and the second robotic device 124 may pick up the moldy and immature ears of corn. By way of further example, in some embodiments of the system a non-robotic sorting device may remove ears of corn comprising husky material for husking and one or more robotic devices may pick up ears of corn downstream of the non-robotic sorting device which have other defined characteristics.

Further, in some embodiments the first robotic device 122 and the second robotic device 124 may be configured to pick up or otherwise move the identified ear corn from a first group and a second group, respectively. For example, FIG. 2 shows a perspective view of a portion of an embodiment of the system of FIG. 1. In this embodiment the first robotic device 122 may be positioned along a first side of the conveyor belt 102 and the second robotic device 124 may be positioned along a second side of the conveyor belt. Thereby, the first robotic device 122 may be configured to pick up the identified ear corn from a first group positioned within a first area 142 and place the identified ear corn from the first group in the alternate location. Further, the second robotic device 124 may be configured to pick up the identified ear corn from a second group positioned within a second area 144 and place the identified ear corn from the second group in the alternate location or a different alternate location. Thereby, in some embodiments the robotic devices 122, 124 may be configured to pick up portions of the identified ear corn such as may be divided based on location on the processing path 106 or defined characteristic. Note that by dividing the processing path 106 into separate first 142 and second 144 areas for picking up ear corn respectively by the first robotic device 122 and the second robotic device 124, collision between the robotic devices may be avoided. However, in other embodiments the robotic devices 122, 124 may share overlapping areas of the processing path and hence control logic may be employed to avoid collision.

With further regard to the ear corn sorting stage 110, various embodiments of ear corn movement along the processing path 106 may be employed. For example, in some embodiments the ear corn sorting stage 110 may be configured to sort ear corn while the ear corn is being transported along the processing path 106. For example, the conveyor belt 102 may run continuously, and the control logic employed to direct movement of the first robotic device 122 and the second robotic device 124 may be configured to account for continuous movement of the identified ear corn along the processing path 106. In other embodiments the ear corn sorting stage 110 may be configured to sort ear corn while the ear corn is temporarily paused along the processing path 106. For example, the conveyor belt 102 may be configured to stop at regular intervals, and the first robotic device 122 and the second robotic device 124 may be configured to pick up the identified ear corn when the conveyor belt is stopped. Waiting for the conveyor belt 102 to stop may facilitate picking up the identified ear corn by allowing the robotic devices to pick up substantially stationary ear corn. In a further example embodiment identification of the ear corn having a defined characteristic may occur while the ear corn are temporarily paused along the processing path 106, while picking up the ear corn may occur while the ear corn are being transported along the processing path. Accordingly various embodiments of pausing and/or moving the ear corn to facilitate identifying and picking up ear corn may be employed as may be understood by one having skill in the art.

Additionally, in some embodiments the conveyor belt 102 may be controlled by a controller which employs a variable-frequency drive (“VFD”) or other controller which is configured to vary the speed of the conveyor belt. In this regard, for example, the controller may be configured to adapt the speed of the conveyor belt 102 to a maximum speed which permits the sensor devices 112, 116 and the robotic devices 122, 124 to perform their specified functions (e.g. identifying ear corn having at least one defined characteristic and picking up ear corn having an identified characteristic, respectively). For example, the controller may thereby slow down the conveyor belt 102 when ear defect rates or ear picking frequencies increase. In this regard, the number of ear corn with defined characteristics identified per unit time may serve as feedback used to control the drive speed for the conveyor belt 102. Thus, sorting of ear corn may occur at a maximum rate of efficiency without sacrificing the quality of the sorting.

As described above, embodiments of the ear corn sorting stage 110 may be positioned downstream of the ear corn husking stage 108. However, in some embodiments portions of the system 100 for sorting ear corn may additionally or alternatively be located upstream of the ear corn husking stage 108. For example, FIG. 1 further illustrates an ear corn sorting stage 110′ which is positioned upstream of the ear corn husking stage. The upstream ear corn sorting stage 110′ may include some or all of the components discussed above with respect to the downstream ear corn sorting stage 110. For example, in the illustrated embodiment, the upstream ear corn sorting stage 110′ may include some or all of a first sensor device 112′, a second sensor device 116′, a light source 118′, a second light source 120′, a first robotic device 122′, and a second robotic device 124′. These components may have similar functions to those described above with respect to the components of the downstream ear corn sorting stage 110, and hence they will not be discussed in detail for purposes of brevity.

However, due to the upstream position of the ear corn sorting stage 110′ relative to the ear corn husking stage 108, the upstream ear corn sorting stage may serve alternate or additional purposes. For example, the upstream ear corn sorting stage 110′ may use one or more of the sensor devices 112′, 116′ to identify ear corn which already have husk material removed. In such instances the defined characteristic may comprise a lack of husk material which the one or more sensor devices 112′, 116′ may identify and locate. In this regard, husk material may be removed from some ear corn during the harvesting process and hence the husked ear corn may not require further husking when introduced into the system 100. In particular, when ear corn are already husked, it may not be desirable to direct the ear corn through the ear corn husking stage 108 because the ear corn husking stage may remove kernels from the husked corn instead of the intended husk material, which could decrease the ultimate output of seed in embodiments in which the system is used to produce corn seed.

Thus, one or more of the robotic devices 122′, 124′ may be used to pick up or otherwise move de-husked ear corn 146 to a third processing path 148′ which bypasses the ear corn husking stage 108 to thereby prevent removal of kernels at this stage. In particular, the third processing path 148′ may return the de-husked ear corn 146 to the processing path 106 downstream of the ear corn husking stage 108. Further, in some embodiments the upstream ear corn sorting stage 110′ may be configured to direct ear corn which are partially de-husked or comprise other features which indicate that the ear corn should undergo less rigorous husking through a less rigorous ear corn husking stage (not shown). For example, older ear corn which have dried more and hence may be identifiable by husk material which is generally more brown in color than younger, more moist husk material that is generally green in color, may be directed to the less rigorous ear corn husking stage by the upstream ear corn sorting stage 110′. Older, drier ear corn may have husks which are removable more easily, and hence less rigorous husking may be desirable. It is notable that the robotic devices 122′, 124′ may be more suited for moving the ear corn upstream of the ear corn husking stage 108 than traditional non-robotic ear corn sorting devices because robotic devices may be able to pick up individual ear corn despite husks, stalks, and other material potentially being present upstream of the ear corn husking stage. Note also that in some embodiments the system may not comprise an ear corn husking stage because husking may occur prior to arrival of the corn at the system.

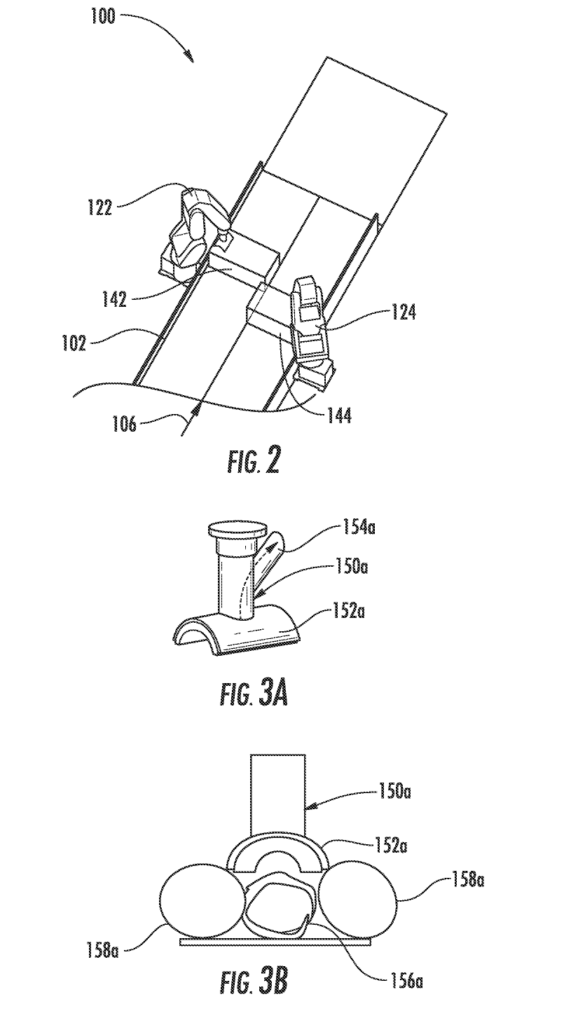

With further regard to facilitating picking up ear corn, FIGS. 3-5 illustrate embodiments of grasping devices 150a-c which may be attached to the robotic devices 122, 124 in order to pick up the identified ear corn. As illustrated in FIG. 3A, a first embodiment of a grasping device 105a may comprise a tip 152a in the form of a portion of a cylinder which is sized and shaped to receive an ear of corn. Use of this configuration may thereby involve rotation of the grasping device 150a or the robotic device to which the grasping device is attached in order to grasp ear corn when the ear corn is randomly arranged. The grasping device 150a may be vacuum-assisted in order to facilitate picking up the ear of corn as illustrated by the vacuum connection 154a. However, as illustrated in FIG. 3B, when an identified ear corn 156a is tightly sandwiched between two other ears of corn 158a, the tip 152a of the grasping device 150a may not be able to contact and grasp the identified ear corn.

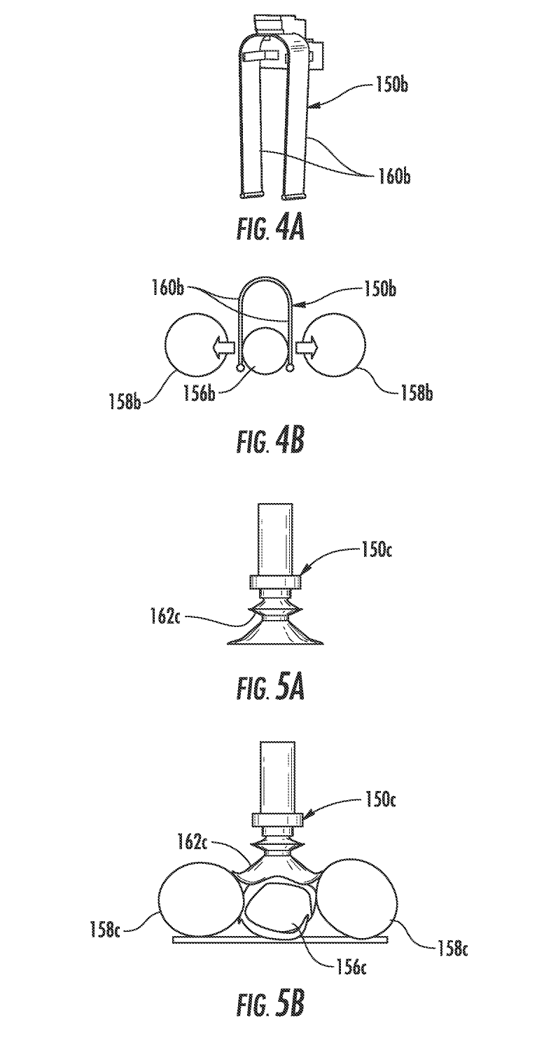

Accordingly, a second embodiment of a grasping device 150b, as illustrated in FIG. 4A, is provided. The grasping device 150b may comprise a pair of prongs 160b which are configured to grasp ears of corn. This configuration may also involve rotation of the grasping device 150a or the robotic device to which the grasping device is attached in order to grasp ear corn when the ear corn is randomly arranged. As shown in FIG. 4B, when the grasping device 150b is used to pick up an identified ear of corn 156b, the prongs 160b expand around the identified ear of corn while applying inwardly directed force against the identified ear corn. During this process the prongs 160b may push away other ear corn 158b which are located near the identified ear corn 156b. Thereby, the prongs 160b may allow grasping of ear corn even when the ear corn are positioned near one another.

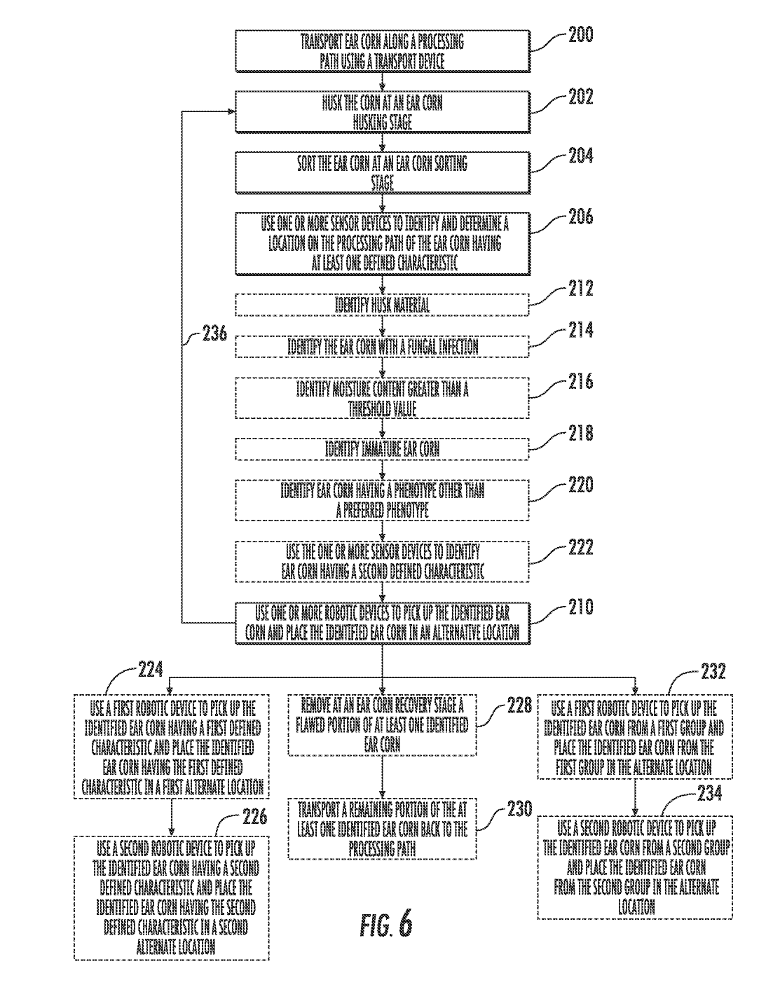

A third embodiment of a grasping device 150c is illustrated in FIG. 5A. The grasping device 150c may comprise a suction tip 162c which may be vacuum-assisted in order to facilitate picking up ear corn. Use of a round suction tip 162c may not require rotation of the grasping device 150c in order to grasp ear corn due to the symmetric configuration of the suction tip. As illustrated in FIG. 5B, the third embodiment of the grasping device 150c may also be configured to grasp identified ear corn 156c positioned between other ear corn 158c. In this regard, the suction tip 162c may comprise a material such as rubber which is configured to flex. Thereby, although the edges of the suction tip 162c may come into contact with the other ear corn 158c, the suction tip may still be able to contact and grasp the identified ear corn 156c. However, various other embodiments of grasping devices may be used in alternate embodiments, and the above-described grasping devices 150a -c are provided only for example purposes.

In further embodiments methods of sorting ear corn are also provided. For example, one method of sorting ear corn is illustrated in FIG. 6. The method may comprise transporting ear corn along a processing path using a transport device at operation 200. For example, the conveyor belt 102 may transport ear corn 104 along the processing path 106. The processing path 106 may include an ear corn husking stage 108, and hence the method may further comprise husking the corn at an ear corn husking stage at operation 202. Further, the method may include sorting the ear corn at an ear corn sorting stage located along the processing path downstream from the ear corn husking stage at operation 204. In some embodiments sorting the ear corn at operation 204 may occur while the ear corn is being transported along the processing path at operation 200. In other embodiments sorting the ear corn at operation 204 may occur while the ear corn is temporarily paused along the processing path. The ear corn sorting stage 110 may comprise a number of components which perform a plurality of functions. In this regard, sorting the ear corn may comprise using one or more sensor devices to identify and determine a location on the processing path of the ear corn having at least one defined characteristic at operation 206. For example, identifying the at least one defined characteristic may involve use of the first sensor device 112, and determining location on the processing path may involve use of the second sensor device 116. By way of further example, the first sensor device 112 may be used to set one or more control limits, and the second sensor device 116 may be used to determine the location of ear corn meeting or exceeding the control limits. However, in some embodiments a single sensor device may identify the defined characteristic and determine location on the processing path, and in some embodiments the single sensor may comprise a machine-vision sensor device. Additionally, the method may comprise using one or more robotic devices to pick up or otherwise move the identified ear corn and place the identified ear corn in an alternate location at operation 210. For example, the first robotic device 122 and/or the second robotic device 124 may pick up the identified ear corn. Further, in some embodiments the first sensor device 112 and/or the second sensor device 116 may be included on one or more of the robotic devices 122, 124. However, the first sensor device 112 or the second sensor device 116 may be located in alternate locations in other embodiments, such as fixed locations above the conveyor belt 102.

In some embodiments the method may additionally or alternatively comprise other operations including those operations illustrated in dashed lines in FIG. 6. For example, the method may include using one or more sensor devices, such as the first sensor device 112, to identify husk material at operation 212, identify moldy ear corn kernels at operation 214, identify moisture content greater than a threshold valve at operation 216, identify immature ear corn at operation 218, and/or identify ear corn having a phenotype other than a preferred phenotype at operation 220. Further, the method may comprise using a third sensor device to identify ear corn having a second defined characteristic at operation 222. In some embodiments the second defined characteristic may comprise one of the above-described defined characteristics as identified in operations 212-220.

Using one or more robotic devices, such as the first robotic device 122 and the second robotic device 124, to pick up the identified ear corn and place the identified ear corn in an alternate location at operation 210 may include a variety of different embodiments. For example, in one embodiment the method may further comprise using a first robotic device to pick up the identified ear corn having a first defined characteristic and place the identified ear corn having the first defined characteristic in a first alternate location at operation 224. Thereby, the method may further comprise using a second robotic device to pick up the identified ear corn having a second defined characteristic and place the identified ear corn having the second defined characteristic in a second alternate location at operation 226.

In a further embodiment the alternate location may comprise the ear corn recovery stage 136 and hence the method may comprise removing at the ear corn recovery stage a flawed portion of at least one identified ear corn at operation 228, wherein the flawed portion contains the defined characteristic. Thereby, the method may additionally include transporting a remaining portion of the at least one identified ear corn back to the processing path at operation 230. For example, the flawed portion 138 may be moved to the disposal location 126, whereas the remaining portion 140 may be returned to the processing path 106.

In an additional embodiment the method may comprise using a first robotic device to pick up the identified ear corn from a first group and place the identified ear corn from the first group in the alternate location at operation 232. Further, the method may include using a second robotic device to pick up the identified ear corn from a second group and place the identified ear corn from the second group in the alternate location at operation 234. For example, the first robotic device 122 may pick up the identified corn from the first group from a first side of the conveyor belt and the second robotic device 124 may pick up the identified ear corn from a second group from a second side of the conveyor belt. In an additional embodiment, as indicated at arrow 236, the alternate location may comprise the second processing path 134 that leads the identified ear corn back to the ear corn husking stage at operation 202. However, in other embodiments the alternate location may comprise the disposal location 126.

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of sorting ear corn, said method comprising:
transporting ear corn along a processing path using a transport device, the processing path including an ear corn husking stage; and
sorting the ear corn at an ear corn sorting stage located along the processing path downstream from the ear corn husking stage,
wherein sorting the ear corn comprises:
using one or more sensor devices to identify and determine a location on the processing path of the ear corn having at least one defined characteristic; and
using one or more robotic devices to pick up the identified ear corn and place the identified ear corn in an alternate location.

2. The method of sorting ear corn of claim 1, wherein the one or more sensor devices comprise a machine-vision sensor device.

3. The method of sorting ear corn of claim 1, wherein using the one or more sensor devices comprises using a first sensor device to identify the at least one defined characteristic and using a second sensor device to determine the location on the processing path.

4. The method of sorting ear corn of claim 3, wherein using the first sensor device comprises using the first sensor device to set one or more control limits, and
wherein using the second sensor device comprises using the second sensor device to determine the location of ear corn meeting or exceeding the control limits.

5. The method of sorting ear corn of claim 1, wherein using the one or more sensor devices comprises using the one or more sensor devices to identify husk material.

6. The method of sorting ear corn of claim 1, wherein using the one or more sensor devices comprises using the one or more sensor devices to identify ear corn with a fungal infection.

7. The method of sorting ear corn of claim 1, wherein using the one or more sensor devices comprises using the one or more sensor devices to identify moisture content greater than a threshold value.

8. The method of sorting ear corn of claim 1, wherein using the one or more sensor devices comprises using the one or more sensor devices to identify immature ear corn.

9. The method of sorting ear corn of claim 1, wherein using the one or more sensor devices comprises using the one or more sensor devices to identify ear corn having a phenotype other than a preferred phenotype.

10. The method of sorting ear corn of claim 1, wherein the one or more sensor devices are included on one or more of the robotic devices.

11. The method of sorting ear corn of claim 1, wherein the alternate location comprises a second processing path that leads the identified ear corn back to the ear corn husking stage.

12. The method of sorting ear corn of claim 1, wherein the alternate location comprises an ear corn recovery stage, and wherein the method further comprises:
removing at the ear corn recovery stage a flawed portion of at least one identified ear corn, wherein the flawed portion contains the defined characteristic; and
transporting a remaining portion of the at least one identified ear corn back to the processing path.

13. The method of sorting ear corn of claim 1, wherein the alternate location comprises a disposal location.

14. The method of sorting ear corn of claim 1, wherein sorting the ear corn further comprises using the one or more sensor devices to identify ear corn having a second defined characteristic.

15. The method of sorting ear corn of claim 1, wherein using the one or more robotic devices comprises using a first robotic device to pick up the identified ear corn from a first group and place the identified ear corn from the first group in the alternate location and using a second robotic device to pick up the identified ear corn from a second group and place the identified ear corn from the second group in the alternate location.

16. The method of sorting ear corn of claim 1, wherein using the one or more robotic devices comprises using a first robotic device to pick up the identified ear corn having a first defined characteristic and place the identified ear corn having the first defined characteristic in a first alternate location and using a second robotic device to pick up the identified ear corn having a second defined characteristic and place the identified ear corn having the second defined characteristic in a second alternate location.

17. The method of sorting ear corn of claim 1, wherein sorting the ear corn occurs while the ear corn is being transported along the processing path.

18. The method of sorting ear corn of claim 1, wherein sorting the ear corn occurs while the ear corn is temporarily paused along the processing path.

19. A system for sorting ear corn, said system comprising:
a transport device configured to transport ear corn along a processing path;
an ear corn husking stage located along the processing path and configured to remove husks from the ear corn; and
an ear corn sorting stage located along the processing path downstream from the ear corn husking stage and configured to sort the ear corn,
wherein the ear corn sorting stage comprises:
one or more sensor devices configured to identify and determine a location on the processing path of the ear corn having at least one defined characteristic; and
one or more robotic devices configured to pick up the identified ear corn and place the identified ear corn in an alternate location.

20. The system for sorting ear corn of claim 19, wherein the one or more sensor devices comprise a machine-vision sensor device.

21. The system for sorting ear corn of claim 19, wherein the defined characteristic comprises husk material.

22. The system for sorting ear corn of claim 19, wherein the defined characteristic comprises ear corn with a fungal infection.

23. The system for sorting ear corn of claim 19, wherein the defined characteristic comprises moisture content greater than a threshold value.

24. The system for sorting ear corn of claim 19, wherein the defined characteristic comprises immature ear corn.

25. The system for sorting ear corn of claim 19, wherein the defined characteristic comprises ear corn having a phenotype other than a preferred phenotype.

26. The system for sorting ear corn of claim 19, wherein the alternate location comprises a second processing path configured to lead the identified ear corn back to the ear corn husking stage.

27. The system for sorting ear corn of claim 19, wherein the alternate location comprises an ear corn recovery stage configured to remove a flawed portion of at least one identified ear corn, wherein the flawed portion contains the defined characteristic, and transport a remaining portion of the at least one identified ear corn back to the processing path.

28. The system for sorting ear corn of claim 19, wherein the alternate location is a disposal location.

29. The system for sorting ear corn of claim 19, wherein the one or more sensor devices are configured to identify ear corn having a second defined characteristic.

30. The system for sorting ear corn of claim 19, wherein the one or more sensor devices comprise a first sensor device configured to identify the at least one defined characteristic and a second sensor device configured to determine the location on the processing path.

31. The system for sorting ear corn of claim 30, wherein the first sensor device is included on one or more of the robotic devices.

32. The system for sorting ear corn of claim 30, wherein the second sensor device is included on one or more of the robotic devices.

33. The system for sorting ear corn of claim 19, wherein the one or more robotic devices comprise a first robotic device and a second robotic device, wherein the first robotic device is configured to pick up the identified ear corn from a first group and place the identified ear corn from the first group in the alternate location, and wherein the second robotic device is configured to pick up the identified ear corn from a second group and place the identified ear corn from the second group in the alternate location.

34. The system for sorting ear corn of claim 19, wherein the one or more robotic devices comprise a first robotic device and a second robotic device, wherein the first robotic device is configured to pick up the identified ear corn having a first defined characteristic and place the identified ear corn having the first defined characteristic in a first alternate location, and wherein the second robotic device is configured to pick up the identified ear corn having a second defined characteristic and place the identified ear corn having the second defined characteristic in a second alternate location.

35. The system for sorting ear corn of claim 19, wherein the ear corn sorting stage is configured to sort ear corn while the ear corn is being transported along the processing path.

36. The system for sorting ear corn of claim 19, wherein the ear corn sorting stage is configured to sort ear corn while the ear corn is temporarily paused along the processing path.

37. A method of sorting ear corn, said method comprising:
transporting ear corn along a processing path using a transport device; and
sorting the ear corn at an ear corn sorting stage located along the processing path,
wherein sorting the ear corn comprises:
using one or more sensor devices to identify and determine a location on the processing path of the ear corn having at least one defined characteristic; and
using one or more robotic devices to pick up the identified ear corn and place the identified ear corn in an alternate location.

38. A system for sorting ear corn, said system comprising:
a transport device configured to transport ear corn along a processing path; and
an ear corn sorting stage located along the processing path and configured to sort the ear corn,
wherein the ear corn sorting stage comprises:
one or more sensor devices configured to identify and determine a location on the processing path of the ear corn having at least one defined characteristic; and
one or more robotic devices configured to pick up the identified ear corn and place the identified ear corn in an alternate location.
